(19) United States
(12) Patent Application Publication
(10) Pub. No.: US 2013/0175149 A1
(43) Pub. Date: Jul. 11, 2013

(54) BUTTON SPRING

(71) Applicant: Michael Wuttikorn Ekbundit, Mount Washington, KY (US)

(72) Inventor: Michael Wuttikorn Ekbundit, Mount Washington, KY (US)

(73) Assignee: GENERAL ELECTRIC COMPANY, Schenectady, NY (US)

(21) Appl. No.: 13/346,953

(22) Filed: Jan. 10, 2012

(51) Int. Cl. H01H 13/14

(52) U.S. Cl. 200/341

(57) ABSTRACT

The present subject matter discloses a button spring. The button spring includes a first beam and a second beam that extend from an edge of a button spring hole. The first and second beams are connected by a cross-member, and a third beam extends from the cross-member and between the first and second beam.

### FIELD OF THE INVENTION

The present subject matter generally relates to a button spring and, more specifically, to a button spring for an appliance.

### BACKGROUND OF THE INVENTION

An appliance generally includes a control panel that has a plurality of buttons. The buttons of the control panel are configured to allow a user to input commands to the appliance. Through the input of such commands, the user may control the operation of the appliance.

The design of the buttons on the control panel is important to the overall consumer satisfaction with the appliance. To satisfy consumers, the buttons must have a satisfactory fit and feel. Thus, the buttons should be small to fit within a limited space provided by the control panel and should provide a soft feel to consumers as they depress the button.

Currently, many buttons on control panels of appliances include button springs that are designed to adjust from an undepressed configuration to a depressed configuration when a user of the appliance pushes the button and return to the undepressed configuration when the user releases the button. The design of such button springs affects the fit and feel of the buttons on the control panel.

In addition, the button springs of such buttons typically include a shaft that is designed to communicate with switches on the control panel. The shaft generally projects from a bottom surface of the button spring towards the switch of the control panel and communicates with the switch of the control panel when the button spring is in the depressed configuration. However, in many current button spring designs, the shaft of the button spring tends to drift when the button spring is depressed—i.e., the shaft does not consistently displace to the same point on the switch of the control panel. Thus, the shaft of the button spring may not suitably communicate with the switch of the control panel on a consistent basis.

Accordingly, button spring designs are needed that fit within the limited space of the control panel, provide a soft feel to consumers, and reduce drift of the shaft.

### BRIEF DESCRIPTION OF THE INVENTION

Aspects and advantages of the invention will be set forth in part in the following description, or may be obvious from the description, or may be learned through practice of the invention.

In one embodiment, the present subject matter discloses a button spring configured to be selectively adjusted from an undepressed configuration to a depressed configuration. The button spring includes a substantially planar element. The substantially planar element defines a first beam extending from an edge of the substantially planar element, a second beam extending from the edge of the substantially planar element, a cross-member having a first end adjacent a distal end of the first beam and a second end adjacent a distal end of the second beam, and a third beam extending from the cross-member and between the first beam and the second beam.

In an additional embodiment, the present subject matter discloses an appliance that includes a substantially planar element and at least one button spring defined by the substantially planar element. The at least one button spring is adapted to be selectively adjusted between a depressed configuration and an undepressed configuration and further configured to selectively communicate with a switch of the appliance. At least one of the at least one button spring defines a first beam with a proximate end of the first beam being adjacent an edge of the substantially planar element, a second beam with a proximate end of the second beam being adjacent the edge of the substantially planar element, a cross-member having a first end adjacent a distal end of the first beam and a second end adjacent a distal end of the second beam, and a third beam with a proximate end of the third beam being adjacent the cross-member and a distal end of the third beam being disposed between the first beam and the second beam.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a front view of a dishwasher according to an exemplary embodiment of the present subject matter;

FIG. 2 illustrates a front view of a washing machine according to an exemplary embodiment of the present subject matter;

FIG. 3 illustrates a top perspective view of a plurality of button springs according to an exemplary embodiment of the present subject matter.

FIG. 4 illustrates a bottom perspective view of the plurality of button springs of FIG. 3 with a particular one of the plurality of button springs in a depressed configuration and a remainder of the plurality of button springs in an undepressed configuration.

FIG. 5 illustrates a top view of a particular one of the plurality of button springs of FIG. 3.

### DETAILED DESCRIPTION OF THE INVENTION

The present subject matter discloses a button spring. The button spring includes a first beam and a second beam that extend from an edge of a button spring hole. The first and second beams are connected by a cross-member, and a third beam extends from the cross-member and between the first and second beam. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

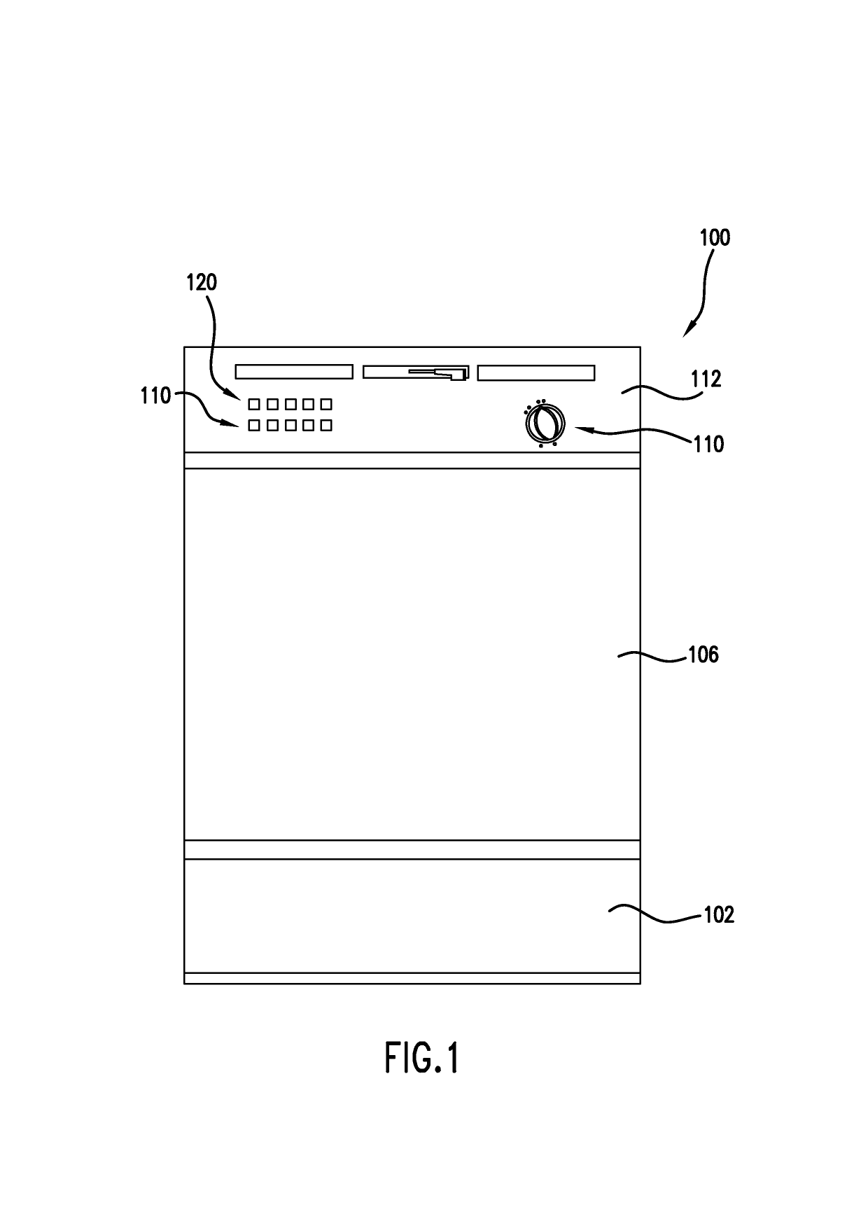

FIG. 1 is a front view of an exemplary dishwasher 100 that includes a cabinet 102 having with a door 106 in a closed position. A control panel 112 is adjacent the cabinet 102, and a variety of appliance control input selectors 110 are coupled to the control panel 112 to allow a washing machine user to control certain functions of the dishwasher 100. The control input selectors includes a plurality of buttons 120.

A wash chamber (not shown) is located within cabinet 102. The wash chamber is accessed by adjusting the door 106 into an open position. In the wash chamber, articles (not shown) are cleaned using methods known in the arts. A motor (not shown) provides power to the wash chamber, and the wash chamber is in fluid communication with one or more pumps and/or drains for the input and removal of water from the wash chamber such as e.g., during a wash or rinse cycle.

The dishwasher 100 is controlled by a processing device or other controller, such as a microprocessor (not shown), according to user preference via manipulation of control input selectors 110 mounted on control panel 112 and/or the plurality of buttons 120 as will be further described. As used herein, the processing device may refer to one or more microprocessors or semiconductors devices and is not restricted necessarily to a single element. The processing device can be programmed to operate the dishwasher 100 according to features desired by the consumer or options selected by the consumer.

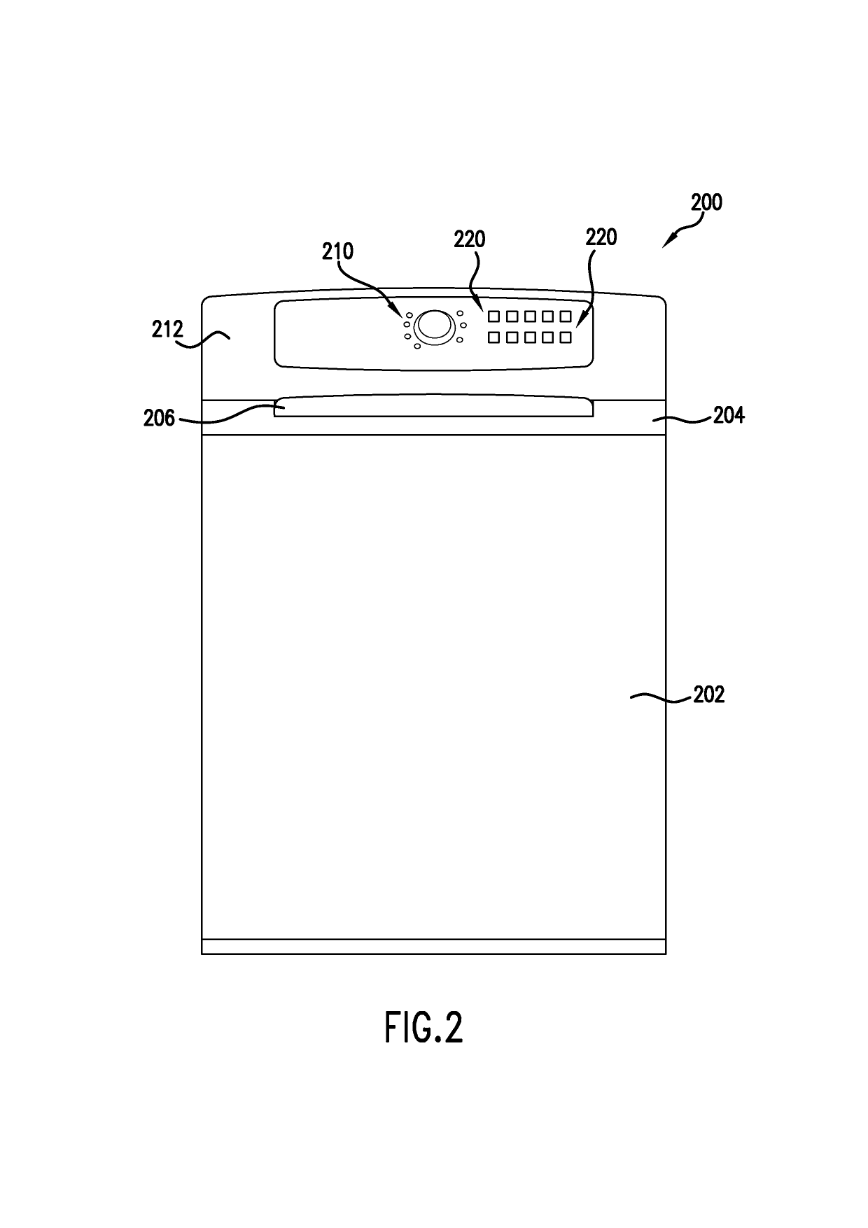

FIG. 2 is a front view of an exemplary vertical axis washing machine 200 that includes a cabinet 202 having a cover 204 with a door 206 in a closed position. A backsplash 212 extends from the cover 204, and a variety of appliance control input selectors 210 are coupled to backsplash 212 to allow a washing machine user to control certain functions of the washing machine 200. The control input selectors includes a plurality of buttons 220.

A wash chamber (not shown) is located within cabinet 202. The wash chamber is accessed by adjusting the door 206 into an open position. In the wash chamber, articles (not shown) are cleaned using methods known in the arts. A motor (not shown) provides power to the wash chamber, and the wash chamber is in fluid communication with one or more pumps and/or drains for the input and removal of water from the wash chamber such as e.g., during a wash or rinse cycle.

The washing machine 200 is controlled by a processing device or other controller, such as a microprocessor (not shown), according to user preference via manipulation of control input selectors 210 mounted on backsplash 212 and/or the plurality of buttons 220 as will be further described. As used herein, processing device may refer to one or more microprocessors or semiconductors devices and is not restricted necessarily to a single element. The processing device can be programmed to operate the washing machine 200 according to features desired by the consumer or options selected by the consumer.

In the embodiments illustrated in FIG. 2, an agitator (not shown) of the washing machine 200 is oriented to rotate about a vertical axis. It is contemplated, however, that the benefits of the present invention can also apply to horizontal axis washing machines as well. More specifically, the dishwasher 100 of FIG. 1 and the washing machine 200 of FIG. 2 are provided by way of example only. Using the teachings disclosed herein, one of ordinary skill in the art will understand the present invention may be used with washing machines of various other configurations in both residential and commercial applications. Additionally, the present invention may also be used with other appliances such as e.g., a clothes dryer, a refrigerator, a microwave, a stove, or an oven.

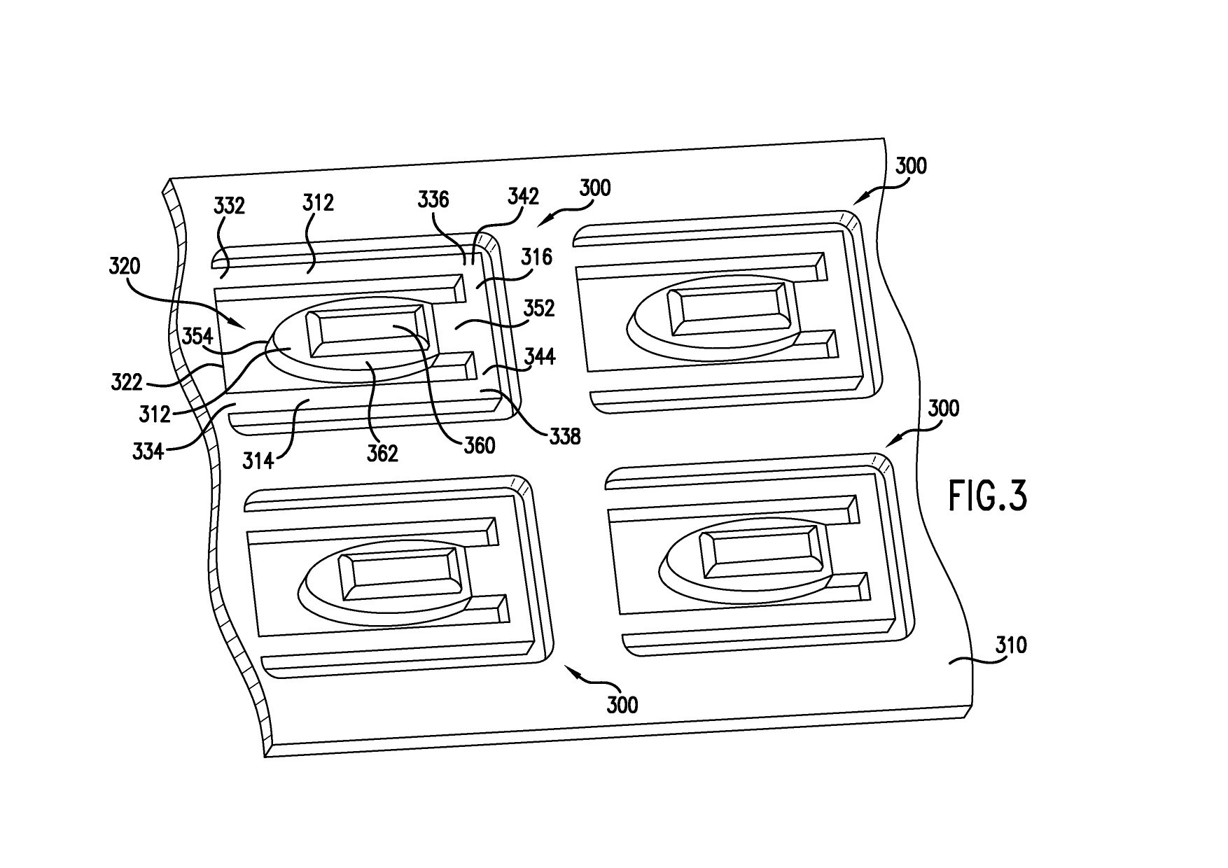

FIG. 3 illustrates a top perspective view of a plurality of button springs 300 according to an exemplary embodiment of the present subject matter. The plurality of button springs 300 of FIG. 3 is suitable for use in a plurality of buttons of an appliance such as e.g., the plurality of buttons 120 of the dishwasher 100 of FIG. 1 and/or the plurality of buttons 220 of the washing machine 200 of FIG. 2. In the exemplary embodiments of FIG. 3, the plurality of button springs 300 is in an undepressed configuration. The undepressed configuration is the configuration that each particular one of the plurality of button springs 300 assumes when an appliance user is not interfacing with the plurality of button springs 300. Thus, in such undepressed configuration, none of the plurality of button springs 300 communicates with a switch of the appliance (not shown)—i.e., no command is being inputted with the plurality of button springs 300 when the plurality of button springs 300 is in the undepressed configuration.

As shown in FIG. 3, the plurality of button springs 300 is defined by a substantially planar element 310. The substantially planar element may be substantially planar when the plurality of button springs 300 is in the undepressed configuration; however, the substantially planar element may deform and become, at least in part, non-planar when any of the plurality of button springs 300 is depressed. To allow the plurality of button springs 300 to change configurations, the substantially planar element may be an elastic material such as e.g., plastic, rubber, or any suitable material. In addition, in the embodiment shown in FIG. 3, the substantially planar element 310 defines a substantially rectangular button spring hole 320. In alternative embodiments, the substantially planar element 310 may define any other suitable shape such as e.g., a circle, an oval, or any other suitable non-circular shape.

As may be seen in FIG. 3, the substantially planar element 310 may define a first beam 312 and a second beam 314. The first beam 312 and the second beam 314 may extend from an edge 322 of the substantially planar element 310. For example, the edge 322 may be one of the edges of the substantially rectangular button spring hole 320. In such example, a proximate end 332 of the first beam 312 may be adjacent the edge 322, and a proximate end 334 of the second beam 314 may be adjacent the edge 322. In the exemplary embodiment shown in FIG. 3, the first and second beams 312,314 have a substantially square cross-section. In alternative embodiments, the first and second beams 312,314 may have any suitable cross-section such as e.g., a circular, rectangular, or oval cross-section. In additional alternative embodiments, the first and second beams 312,314 may have different cross-sectional shapes. In the illustrated exemplary embodiment, the first and second beams are substantially parallel along their respective lengths defined from the respective proximate end 332 or 334 to a respective distal end 336 or 338 of the first and second beams 312,314. However, in alternative embodiments, the first and second beams 312,314 need not be substantially parallel.

As shown in FIG. 3, the substantially planar element 310 may also define a cross-member 316. The cross-member 316 may have a first end 342 disposed adjacent the distal end 336 of the first beam 312 and a second end 344 disposed adjacent the distal end 338 of the second beam 314. In the embodiment, shown in FIG. 3, the first and second beam 312,314 are substantially equal in length, and thus, the cross-member 316 may be substantially perpendicular to the first and second beams 312,314 along a length of the cross-member 316 defined from the first end 342 to the second end 344. However, in alternative embodiments, the first and second beams 312,314 may have different lengths, and thus, the cross-member 316 need not be substantially parallel to the first and second beams 312,314. In the exemplary embodiment shown in FIG. 3, the cross-member 316 has a substantially square cross-section. In alternative embodiments, the cross-member 316 may have any suitable cross-section such as e.g., a circular, rectangular, or oval cross-section. In additional alternative embodiments, the cross-member 316 may have a different cross-sectional shape than the first and/or second beams 312,314.

As may be seen in FIG. 3, the substantially planar element 310 may further define a third beam 318. The third beam 318 may extend from the cross-member 316 and between the first and second beams 312,314. For example, the third beam 316 may extend between the first and second beams 312,314 such that a distal end 352 of the third beam 318 may be disposed in a cavity defined by the edge 322, the first and second beams 312,314, and the cross-member 316 when a respective one of the plurality of button springs 300 is in the undepressed configuration. As shown in the illustrated exemplary embodiment, a proximate end 354 of the third beam 318 may be substantially equidistant from the first and second ends 342,344 of the cross-member 316. In alternative embodiments, the proximate end 354 of the third beam 318 may be a different distance from the first end 342 and the second end 344. Also, as shown in FIG. 3, the third beam 318 is substantially parallel to the first and second beams 312,314 along a length of the third beam 318 defined from the distal end 352 to the proximate end 354. However, in alternative embodiments, the third beam 318 need not be parallel to the first and second beams 312,314. In addition, in the exemplary embodiment shown in FIG. 3, the third beam 318 defines a substantially oval profile relative to the button spring hole 320. In alternative embodiments, the third beam 318 may have any suitable profile such as e.g., circular or rectangular.

As may be seen in FIG. 3, the substantially planar element 310 may further define a knob 360 disposed on a top surface 362 of the third beam 318. As shown in FIG. 3, a top surface of the knob 362 is not co-planar with the substantially planar element 310, the first, second, and third beams 312, 314, 318, or the cross-member 316 when the respective one of the plurality of button springs 300 is in the undepressed configuration. The knob 360 may be configured to assist the user in interfacing with the appliance e.g., by providing a texture to enable the user to better feel the respective one of the plurality of button springs 300. Also, in the embodiment shown in FIG. 3, the knob 360 defines a substantially rectangular profile. In alternative embodiments, the knob 360 may have any suitable profile such as e.g., a circular or oval profile. In addition, the knob 360 may be rounded such that the knob 360 is a half-sphere or other similar shape.

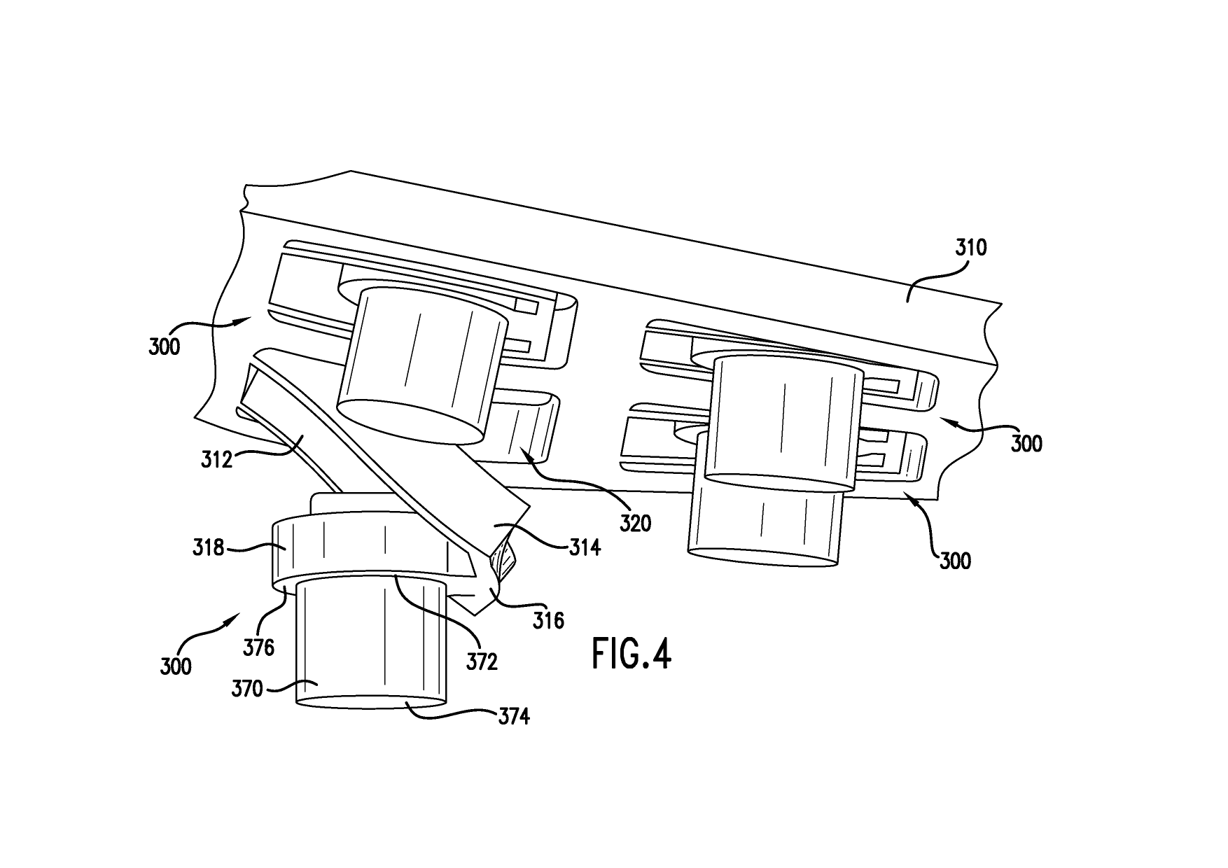

FIG. 4 illustrates a bottom perspective view of the plurality of button springs of FIG. 3 with a particular one of the plurality of button springs 300 in a depressed configuration and a remainder of the plurality of button springs 300 in an undepressed configuration. In the exemplary embodiment of FIG. 4, each particular one of the plurality of button springs 300 includes a shaft 370 disposed on a bottom surface 376 of the respective third beam 318. In such exemplary embodiment, the shaft 370 has a proximate end 372 adjacent the third beam 318 and a distal end 374. The distal end 374 is configured to communicate with the switch of the appliance such that when the particular one of the plurality of button springs 300 is depressed the distal end 374 communicates with the switch. In the embodiment shown in FIG. 4, the shaft 370 has a substantially circular cross-section. In alternative embodiments, the shaft 370 may have any other suitable cross-sections such as e.g., an oval or rectangular cross-section. Also, the shaft 370 may have a rounded distal end 374, e.g., the shaft 370 may be a half-sphere. In additional exemplary embodiments, the bottom surface 376 of the third beam 318 may communicate with the switch of the appliance directly.

In addition, in the embodiment shown in FIG. 4, the particular one of the plurality of button springs 300 is in a depressed configuration. Like in the undepressed configuration shown in FIG. 3 in such configuration, FIG. 4 shows that the first and second beams 312,314 are substantially uniformly shaped in the depressed configuration. Thus, the first and second beams 312,314 may have substantially uniformly deformed from the undepressed to the depressed configuration.

Also shown in FIG. 4, the distal end 352 of the third beam 318 may be disposed outside of the cavity defined by the edge 322, the first and second beams 312,314, and the cross-member 316 when the particular one of the plurality of button springs 300 is in the undepressed configuration.

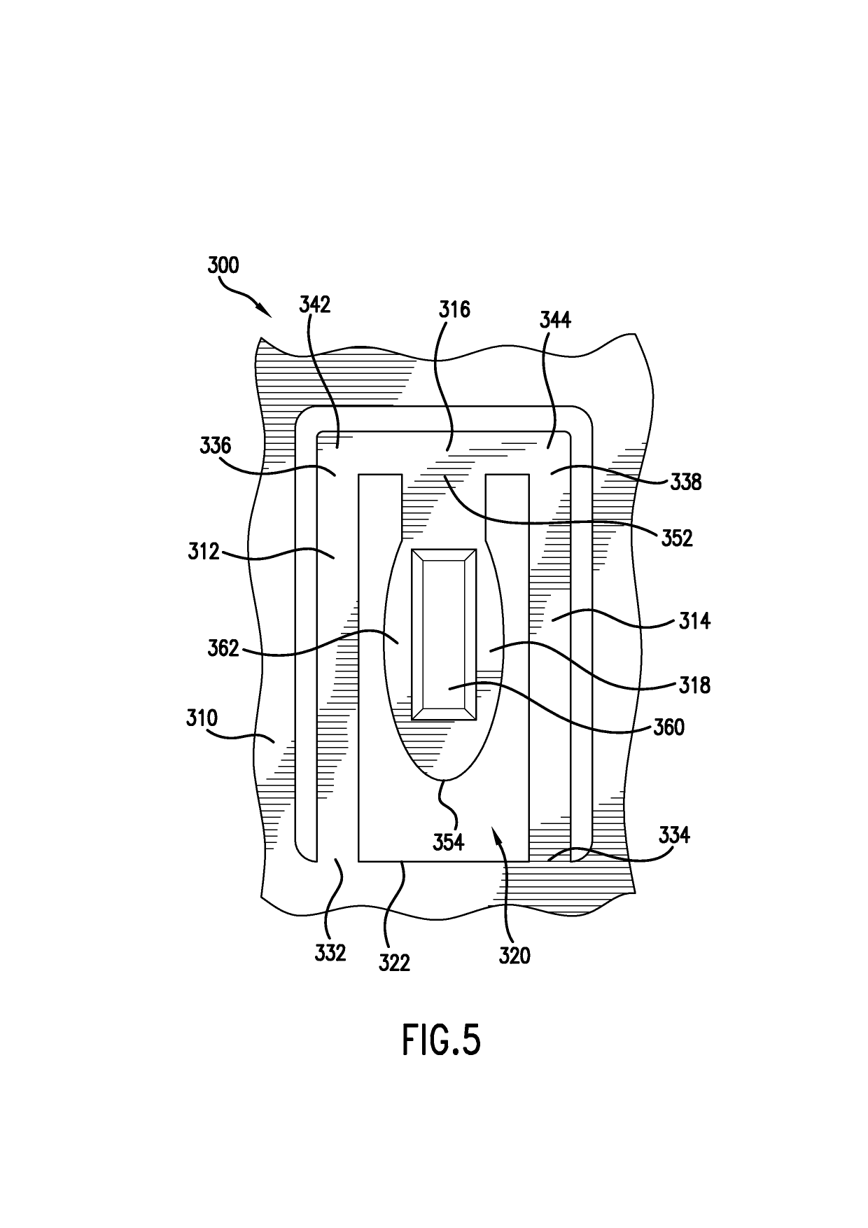

FIG. 5 is a top view of a particular one of the plurality of button springs 300 of FIG. 3. It may be seen in FIG. 5 that a centroid of the third beam 318 may be disposed at about a centroid of the button spring hole 320 when the particular one of the plurality of button springs 300 is in the undepressed configuration. Thus, the geometric center of the third beam 318 may be disposed at about the geometric center of the button spring hole 320 when the particular one of the plurality of button springs 300 is in the undepressed configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A button spring configured to be selectively adjusted from an undepressed configuration to a depressed configuration, the button spring comprising:
a substantially planar element, the substantially planar element defining:
a first beam extending from an edge of the substantially planar element;
a second beam extending from the edge of the substantially planar element;
a cross-member having a first end adjacent a distal end of the first beam and a second end adjacent a distal end of the second beam; and
a third beam extending from the cross-member and between the first beam and the second beam.

2. The button spring of claim 1 further comprising a cavity defined between the first beam and the second beam, wherein a distal end of the third beam is at least partially within the cavity when the button spring is in the undepressed configuration, and the distal end of the third beam is outside of the cavity when the button spring is in the depressed configuration.

3. The button spring of claim 1 wherein the first beam and second beam are substantially parallel.

4. The button spring of claim 3 wherein the third beam is substantially parallel to the first and second beams when the button spring is in the undepressed configuration.

5. The button spring of claim 1 further comprising a shaft extending from a bottom surface of the third beam.

6. The button spring of claim 1 further comprising a knob disposed on a top surface of the third beam.

7. The button spring of claim 6 wherein a centroid of the knob is disposed at about a centroid of the button spring.

8. The button spring of claim 1 wherein the first beam and second beam are substantially uniformly shaped when the button spring is in the depressed configuration and when the button spring is in the undepressed configuration.

9. The button spring of claim 8 wherein the first, second, and third beams are substantially coplanar with the substantially planar element when the button spring is in the undepressed configuration.

10. An appliance comprising:
a substantially planar element;
at least one button spring defined by the substantially planar element, the at least one button spring being adapted to be selectively adjusted between a depressed configuration and an undepressed configuration and further configured to selectively communicate with a switch of the appliance, the at least one button spring defining:
a first beam with a proximate end of the first beam being adjacent an edge of the substantially planar element;
a second beam with a proximate end of the second beam being adjacent the edge of the substantially planar element;
a cross-member having a first end adjacent a distal end of the first beam and a second end adjacent a distal end of the second beam; and
a third beam with a proximate end of the third beam being adjacent the cross-member and a distal end of the third beam being disposed between the first beam and the second beam.

11. The appliance of claim 10, wherein the appliance is a dishwasher, a washing machine, a refrigerator, a stove, or a microwave.

12. The appliance of claim 10 wherein the first beam and second beam are substantially parallel.

13. The appliance of claim 12 wherein the third beam is substantially parallel to the first and second beams when the button spring is in the undepressed configuration.

14. The appliance of claim 10 further comprising a shaft extending from a bottom surface of the third beam.

15. The appliance of claim 10 further comprising a knob disposed on a top surface of the third beam.

16. The appliance of claim 10 wherein the first beam and second beam are substantially uniformly shaped when the button spring is in the depressed configuration and when the at least one button spring is in the undepressed configuration.

17. The appliance of claim 16 wherein the first, second, and third beams are substantially coplanar with the substantially planar element when the at least one button spring is in the undepressed configuration.
